(19) United States
(12) Patent Application Publication
(10) Pub. No.: US 2006/0012138 A1
(43) Pub. Date: Jan. 19, 2006

(54) Child carrier having an electronic device

(76) Inventors: Timothy A. Otterlee, Marietta, GA (US); Rodney L. Hempen, Braselton, GA (US); Graham C. Lobban, St. Clements (CA)

Correspondence Address: WOMBLE CARLYLE SANDRIDGE & RICE, PLLC, P.O. BOX 7037, ATLANTA, GA, 30357-0037, US

(21) Appl. No.: 11/177,769

(22) Filed: Jul. 8, 2005

Related U.S. Application Data
(63) Continuation-in-part of application No. 10/789,296, filed on Feb. 27, 2004.
Application No. 10/789,296 is a continuation-in-part of application No. 10/113,310, filed on Mar. 29, 2002.
(60) Provisional application No. 60/663,336, filed on Mar. 18, 2005.

(51) Int. Cl. B62D 39/00

(52) U.S. Cl. 280/33.993

(57) ABSTRACT

The invention recites a child carrier comprising a seat portion including a seat, a backrest, and a floor. The child carrier further includes a substantially rigid body, at least partially surrounding and supporting the seat portion. The rigid body also includes substantially solid side surfaces and at least partially defines a panel. In addition, the child carrier provides a plurality of wheels supporting the body, and an electronic device supported by the body.

### CROSS-REFERENCE TO RELATED APPLICATION

This application is a continuation-in-part of co-pending U.S. patent application Ser. No. 10/789,296, filed Feb. 27, 2004, which is a continuation-in-part of co-pending U.S. patent application Ser. No. 10/113,310, filed Mar. 29, 2002, both of which are incorporated herein by reference in their entirety, and this application claims priority to U.S. Provisional Application No. 60/663,336, filed Mar. 18, 2005, which also is incorporated herein by reference in its entirety.

### FIELD OF THE INVENTION

The present invention relates to child carriers and, particularly, to formed or molded child carriers having seats for children. More particularly, the present invention relates to formed or molded child carriers that provide entertainment for children.

### BACKGROUND OF THE INVENTION

Child carriers include strollers, shopping carts, attachments to shopping carts, and molded carts commonly used at super markets, home center stores, retail stores, theme parks and zoos. Each year thousands of children are injured in shopping cart, as well as other retail stroller, accidents. Generally, the child becomes bored with the shopping experience and tries to get out of the child carrier. A fall out of a carrier can cause severe injury. In addition, injuries occur when the child pinches his or her fingers in the moving mechanism of a typical seat or when the child reaches out of the carrier to grab something.

Many child carriers are simply wire or plastic mesh constructions that function as containers to carry consumer goods through a store and secondarily provide a seat for a child. Many of these carriers provide seats that are both uncomfortable and easy to escape. If a child becomes bored or uncomfortable, the chances for injury increase. In addition, many of the seats fold or utilize moving pieces that can easily pinch a small child's fingers.

Many child carriers also employ a seat that attaches to a pre-existing cart making the cart/carrier combination larger and heavier than typical child carriers, thus requiring more effort to push and maneuver the cart/carrier combination. Some of these carriers provide rearward looking seats that in many cases make it difficult for the child to observe where the carrier is going.

Other child carriers provide a more comfortable seat but still provide nothing to entertain the child. The child therefore has the tendency to become restless, potentially injuring himself or herself or misbehaving, making shopping more difficult. For example, child carriers used in commercial settings such as shopping malls and in entertainment settings such as zoos and theme parks are often shaped to peak the child's interest but once inside the child quickly becomes bored making the shopping or entertainment experience less enjoyable for the adult.

It is therefore desirable to provide a child carrier that provides an inviting place for a child to sit and also provides some form of entertainment to occupy the child's attention.

### SUMMARY OF THE INVENTION

According to the present invention, a child carrier includes a seat portion including a seat, a backrest, and a floor. The child carrier further includes a substantially rigid body at least partially surrounding and supporting the seat portion. The rigid body also includes substantially solid side surfaces and at least partially defines a panel. In addition, the child carrier provides a plurality of wheels supporting the body, and an electronic device supported by the body.

In another aspect of the present invention, a child carrier provides a substantially rigid basket including a front wall, a rear wall, two side walls, and a base. The child carrier further includes a body defining a basket portion, a seat portion, and a push portion, the basket disposed substantially within the basket portion. In addition, the child carrier provides a plurality of wheels supporting the body and the basket, and an electronic device coupled to the body.

In another aspect, the child carrier includes one or more headphone jacks that receive a signal from the electronic device. In addition, the electronic device is a radio, a video display device, a computer, or video game player, or the like. Further, the electronic device in many aspects is interactive allowing the child to play and interact with the device.

In yet another aspect, the seat portion is disposed between the basket portion and the push portion such that the seat is above the base of the basket. In addition, in some aspects, a first side wall, a second side wall, a rear wall, the panel and the rear wall of the basket substantially surround the seat and the floor.

Thus, for example, the present invention contemplates a shopping cart adapted to carry a rider, the shopping cart comprising a substantially rigid body defining a seat portion and a basket portion, the seat portion including a plurality of walls and a seat, and an electronic device disposed at least partially within the seat portion, wherein the electronic device comprises a display and an interactive device. The electronic device may comprise a game. The display may comprise a flat screen, a plasma screen, a computer screen, or a television screen. The interactive device may comprise a steering wheel, which may be attached to one or more of the plurality of walls. The interactive device may comprise a joystick. The shopping cart may further comprise an electrical connector for receiving a headphone plug, wherein the electronic device produces a signal that is directed to the electrical connector. The shopping cart further may comprise a battery for supplying power to the electronic device.

The present invention also contemplates a shopping cart adapted to carry a rider, the shopping cart comprising a substantially rigid body defining a seat portion and a basket portion, the seat portion including a plurality of walls and a seat, and an electronic device disposed at least partially within the seat portion, wherein the electronic device comprises an audio device. The audio device may comprise a radio receiver, for example, tuned to a pre-determined frequency or an MP3 player. The audio device may broadcast music or a story. The shopping cart further may include an electrical connector for receiving a headphone plug, wherein the electronic device produces a signal that is directed to the electrical connector.

The present invention also contemplates a shopping cart adapted to carry a rider, the shopping cart comprising a substantially rigid body defining a seat portion and a basket portion, the seat portion including a plurality of walls and a seat, and an electronic device disposed at least partially within the seat portion. The electronic device may comprise a video display coupled to a video cassette recorder or a digital videodisk player, a video display device coupled to an audio/video receiver, an audio/video storage device coupled to an audio/video playback device, or any combination thereof. The shopping cart further may comprise an electrical connector for receiving a headphone plug, wherein the electronic device produces a signal that is directed to the electrical connector.

The present invention also encompasses a shopping cart adapted to carry a rider, comprising a substantially rigid body having a front portion and a rear portion, a substantially rigid basket received within an opening defined in the front portion of the body, the basket having a base attached to the body and front, rear, and side walls, a seat disposed along the body adjacent the basket, a panel mounted in front of the seat, and a plurality of wheels attached to the body. The seat region may comprise an audio/video playback device positioned along the panel for access by the rider and an electronic device mounted along the rear portion of the body.

Additional features and advantages will become apparent to those skilled in the art upon consideration of the following detailed description of the invention and the accompanying drawings.

### BRIEF DESCRIPTION OF THE DRAWINGS

The detailed description particularly refers to the accompanying figures in which:

FIG. 1 is a perspective view of a cart in accordance with the invention having an electronic device;

FIG. 2 is a rear view of the cart of FIG. 1, showing another location for the electronic device;

FIG. 3 is a perspective view of the seat portion of the cart of FIG. 1, showing another location for the electronic device;

FIG. 4 is an exploded view of the cart of FIG. 1;

FIG. 5 is a perspective view of the cart of FIG. 1 having an open rear portion;

FIG. 6 is a section view of two nested carts in accordance with the present invention;

FIG. 7 is a perspective view of an exemplary dashboard including an electronic device that may be used in a child carrier in accordance with the present invention;

FIG. 8 is a front and rear perspective view of an exemplary attachable panel including an audio/visual device in accordance with the present invention;

FIG. 9 is a front and rear perspective view of an exemplary integral panel including an audio/visual device in accordance with the present invention;

FIG. 10 is a perspective view of an exemplary shopping cart including a dashboard having an audio/visual device in accordance with the present invention;

FIG. 11 is a perspective view of another exemplary shopping cart including a dashboard having an audio/visual device in accordance with the present invention;

FIG. 12 is an exemplary electronic card including various components for use in a system in accordance with some aspects of the present invention;

FIG. 13 is another exemplary electronic card including various components for use in a system in accordance with some aspects of the present invention;

FIG. 14 is a schematic illustration of an exemplary system according to some aspects of the present invention;

FIG. 15 is a schematic illustration of an exemplary system according to some aspects of the present invention;

FIG. 16 is a schematic illustration of an exemplary system according to some aspects of the present invention; and

FIG. 17 is a perspective view of another child carrier in accordance with the invention, having an electronic device.

### DETAILED DESCRIPTION OF THE DRAWINGS

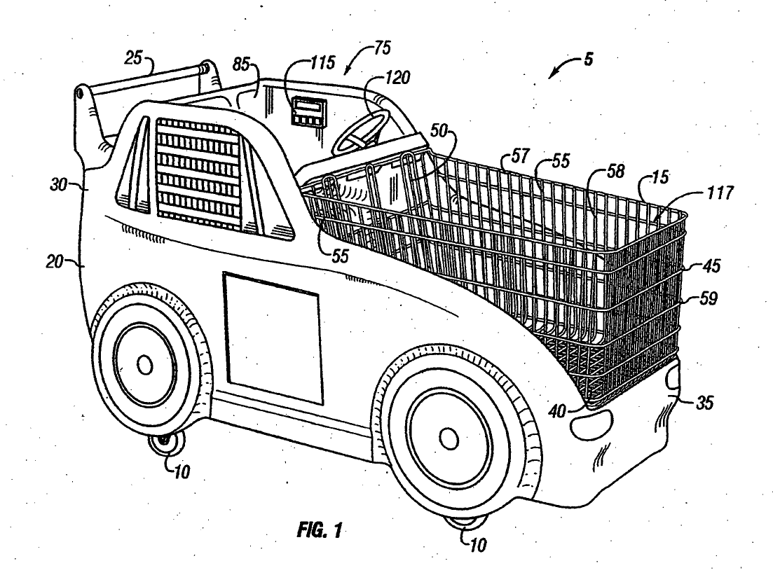

FIGS. 1 through 4 illustrate a shopping cart 5 in accordance with the invention. The cart 5 includes a plurality of wheels 10, a basket 15, a body 20, and a push bar 25. The wheels 10, or castors, engage the body 20 and support the cart 5 on the ground. The push bar 25 engages a rear portion 30 of the body 20 providing a convenient surface to push and steer the cart 5. The basket 15 is supported and partially surrounded by the body 20.

The exemplary carrier illustrated in FIGS. 1 through 4 uses four wheels 10 located near the extreme corners of the body 20 to support the cart 5. The wheels 10 are fairly standard in the industry, and therefore not critical to the invention. The wheels 10 are placed apart from one another to ensure that the cart 5 remains stable even when loaded with merchandise and children. The carrier of FIG. 1 employs four wheels 10, other carriers use only three, while still others use five, six our even more wheels 10. Generally, the rear wheels 10 are aligned and fixed so that they rotate about a common axis. The front wheels 10 on the other hand are generally free to pivot allowing a front portion 35 of the cart 5 to maneuver easily through the narrow aisles commonly found in grocery stores and the like. Other carriers use wheel arrangements in which all of the wheels 10 are pivotable allowing for a more maneuverable cart 5.

The basket 15 illustrated in FIGS. 1 through 4 has a base 40, a front wall 45, a rear wall 50, and two sidewalls 55. A plurality of lateral and transverse wires 57 cross one another to define each wall 45, 50, 55 and the base 40. The wires 57 firmly connect to one another using known attachment processes (e.g., welding, soldering, brazing, adhesives, mechanical fasteners, and the like). The wires 57 are typically, steel or aluminum, but may be formed from other materials (e.g., magnesium, titanium or other metals, composites, or plastics). Generally, the wires 57 are painted or coated with a material to prevent injury and to protect the wires 57 from damage. In one aspect, the four walls 45, 50, 55, and base 40 are made together as a single component. A plurality of U-shaped wires 58 are arranged laterally and transversely to completely define the base 40 and to define the vertical wires of the walls 45, 50, 55. A plurality of ring-shaped wires 59 intertwine with the U-shaped wires 58 to complete the basket 15. The wires 58, 59 are attached to one another or to a basket frame to complete the one-piece basket 15. Other aspects employ multiple pieces to complete a basket 15. For example, an aspect that requires a pivotable rear wall 50 would require the rear wall 50 be made separately from the remainder of the basket 15. It is thus contemplated that the basket 15 can be assembled from any number of individual components. It should also be noted that while a wire mesh basket 15 is shown and discussed herein, the carrier of the present invention may include a solid basket or a basket 15 formed from sheets of plastic rather than wires 57. For example, multiple sheets of plastic formed in any common manner can be attached to one another at adjacent edges to define a basket 15. In this example, each wall 45, 50, 55 along with the base 40 would be separate components attached to one another to complete the basket 15.

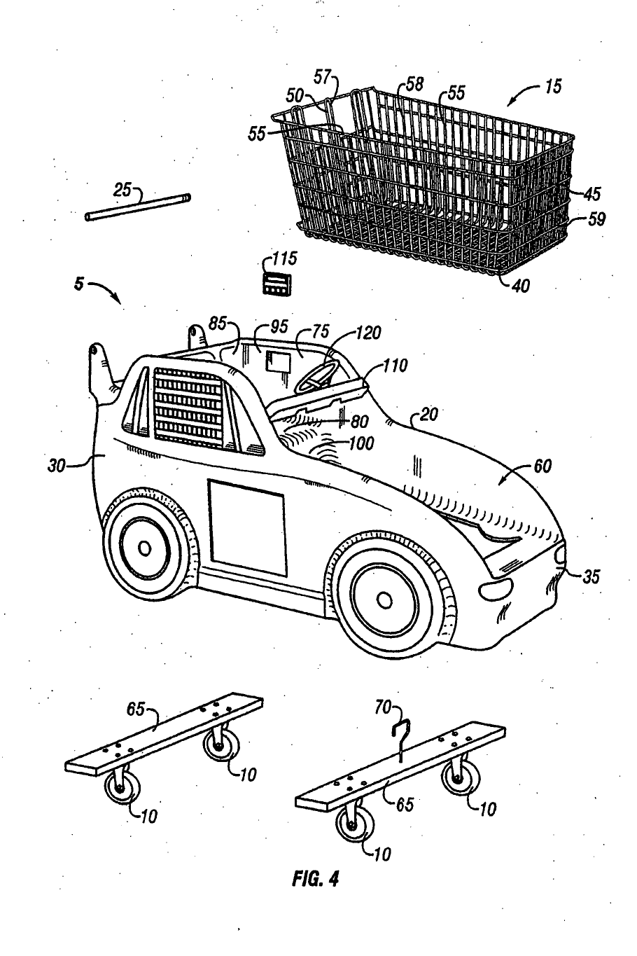

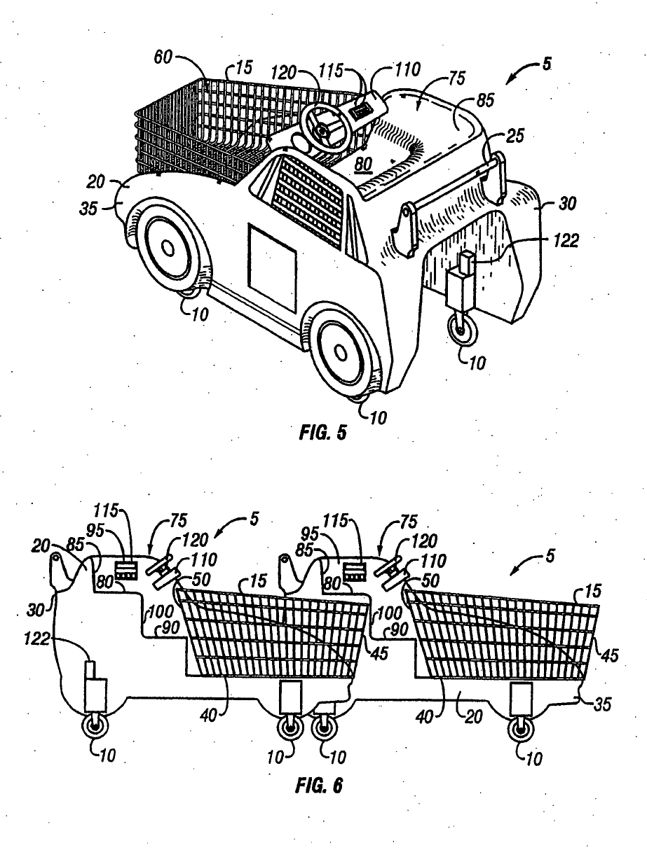

The basket 15 fits within an opening 60 defined by the body 20. The front portion 35 of the body 20 is shaped to accept the basket 15 therein while providing support to the basket 15. The body defines side walls that at least partially cover the side walls of the basket. In one aspect, the side walls cover at least about 10 percent of the surface area of each of the basket sides. In another aspect, the side walls of the body cover at least about 40 percent of the surface area of the basket sides. Once installed, the basket 15 is fixedly attached to the body 20. FIG. 4 illustrates one possible attachment mechanism. In FIG. 4 a brace 65 extends across the bottom of the body 20 to partially support the front wheels 10. A hook-shaped bolt 70 engages the wires 57 of the base 40 of the basket 15 and extends through a hole in the brace 65. A nut (not shown) threads onto the end of the hook-shaped bolt 70 fixedly attaching the basket 15 to the body 20. In another aspect (not shown), bolts and washers extend through the wires 57 of the base 40 of the basket 15. The washers engage the basket 15 while the bolts engage the body 20 firmly clamping the basket 15 to the body 20. In still another aspect, the basket 15 simply sits in the basket opening 60 provided by the body 20. In this aspect, the basket 15 can be removed easily to facilitate storage, nesting of the carts, or delivery of groceries or other products to a vehicle or home.

The body 20 defines the front portion 35, a seat portion 75, and the rear portion 30. The front portion 35 defines the basket opening 60 in which the basket 15 sits when the components are assembled. The seat region 75, illustrated in FIGS. 1 and 3, is disposed above and behind the front portion 35 and further includes a seat 80, a back wall 85, a floor 90, and two sidewalls 95. In addition, a rear kick panel 100 extends from the floor 90 to the seat 80. The seat 80 is sized to support two small children in the seated position. The seat 80, along with the back wall 85, supports the children while the sidewalls 95 obstruct their exit from the cart 5. The children's legs extend into a chamber 105 defined by the two side walls 95, the rear wall 50 of the basket 15, and the rear kick panel 100. The chamber 105 thus completely surrounds the child's legs further enhancing the safety of the cart 5.

Viewing FIG. 3, the seat portion 75 further includes a panel 110 attached to the basket 15 or in some aspects to the body 20. To contain the child further and to provide for entertainment, the panel 110 is disposed such that it may be immediately in front of a child seated in the seat 80. Electronic devices 115, which will be discussed in more detail below, may be attached to or disposed in the front panel 110 to entertain the child. In addition, some aspects employ seat belts (not shown) that allow the shopper to strap the child to the seat 80 if desired. In some constructions, the panel 110 can be removably attached to the cart. The removability would allow the cart owner to remove and securely store the panels 110 if they contain an electronic device. In addition, the removability would allow for easier maintenance and changes to the electronic device.

Many processes and materials are available to manufacture the body 20, but the preferred technique involves the use of a rotomolded plastic. Rotomolding allows the body 20 to be manufactured as a substantially rigid single piece rather than multiple pieces, eliminating weaknesses and reducing cost. Other aspects use processes such as injection molding and hot forming. In addition, while it is important to manufacture a lightweight body, other aspects use materials other than plastic. For example, fiberglass or other composites are light and provide sufficient strength and durability and therefore would be suitable material substitutes. While it is preferable that the body 20 be made in a single operation, other aspects employ several sections manufactured separately and then assembled to one another to complete the body 20.

As illustrated herein, the body is generally formed to resemble an object (e.g., race car, rocket, air craft, boat, dinosaur, and the like) that may be familiar to a child. The body may include a paint scheme, decals, or other accoutrements that further enhance the desired theme. As a result, the child's experience may be enhanced, thereby making the shopping experience more enjoyable for the shopper.

FIG. 1 illustrates an assembled shopping cart 5 in accordance with some aspects of the invention. The body 20 covers a portion of the sides 55 of the basket 15 but leaves the front 45 and the top 117 open. In another aspect, the body 20 extends around the basket 15 substantially covering all the walls 45, 50, 55 leaving only the top 117 fully exposed. To entertain children seated in the seat portion 75 of the cart 5, one or more steering wheels 120 may be attached to the panel 110 to allow the child to play during the shopping experience.

If desired, the child carrier may include an electronic device 115 for entertaining the child while the child is seated in the carrier or walking along side it. More than one electronic device may be provided to entertain multiple children. While various electronic entertainment devices are described herein, it should be understood that various other electronic devices of entertaining the child are contemplated hereby.

In one aspect, the electronic device comprises an audio system. The audio system may include one or more of a variety of components including, but not limited to, a cassette player, compact disc player, minidisk player, digital audio player (e.g., MPEG1-MPEG4, MP1-MP3 player, ACC player, OGG player), radio receiver, satellite radio receiver, internal broadcasting system, or any other audio device or combination of devices. One or more headphones and jacks may be provided to minimize disturbance of other children in the carrier or other patrons. It is contemplated that one or more.

In one example, two headphone jacks are provided within the cart. The jacks may connect to a radio receiver tuned to the frequency of the store's internal broadcast or to any desired frequency. The child can thus listen to music, stories, narratives, plays, monologues, dialogues, audio books, audio comic books, or other entertainment, or any combination thereof provided by the store through the headphones without the sound disturbing other patrons. As one having ordinary skill in the art will realize, headphones can be used for the audio output of any device described herein.

In another aspect, the electronic device comprises a computer or video game. The computer or video game is coupled to the cart 5 in a position that allows a seated child to play the game. A joystick or other interactive device can be coupled to the body 20 of the cart 5 to allow the child to interact with the game. In addition, the steering wheels 120, described above can be interconnected with the game to provide input if desired. A person skilled in the art will realize that many commercially available technologies (e.g., flat screens, plasma screens, closed-circuit television, MP3 players, computers, and the like) can be adapted to the cart 5 or child carrier of the present invention to provide entertainment for children. Small rechargeable batteries 122 hidden within the cart 5 can power many, if not all, of these technologies.

According to another aspect of the present invention, the electronic device comprises an audio/video system. In one aspect, a video display is provided in addition to the audio device previously described. The audio/video system may be positioned in any suitable location in the cart or mounted thereto, as needed for the child to view the video output. The controls for the audio/video system may be accessible by the child or, alternatively, may be positioned outside of the child's reach to prevent tampering. In such an instance, the controls may be located on the handle of the carrier or otherwise, where it is accessible only by the parent or guardian.

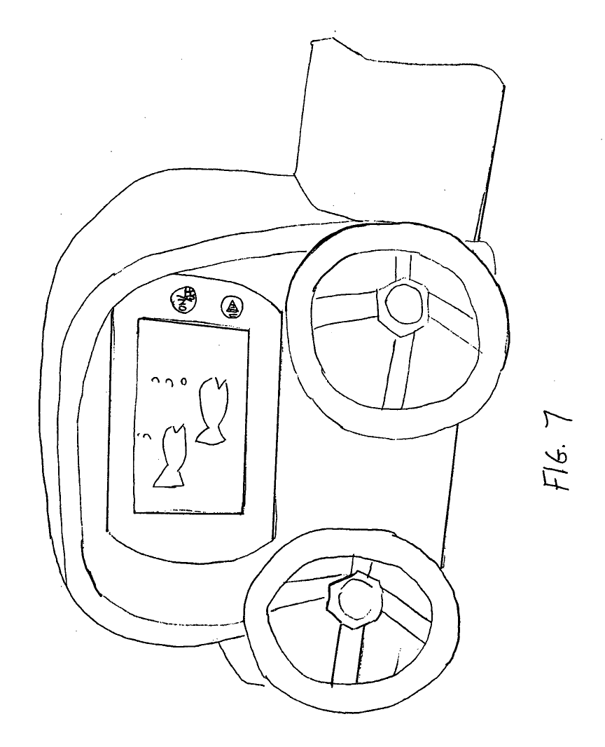

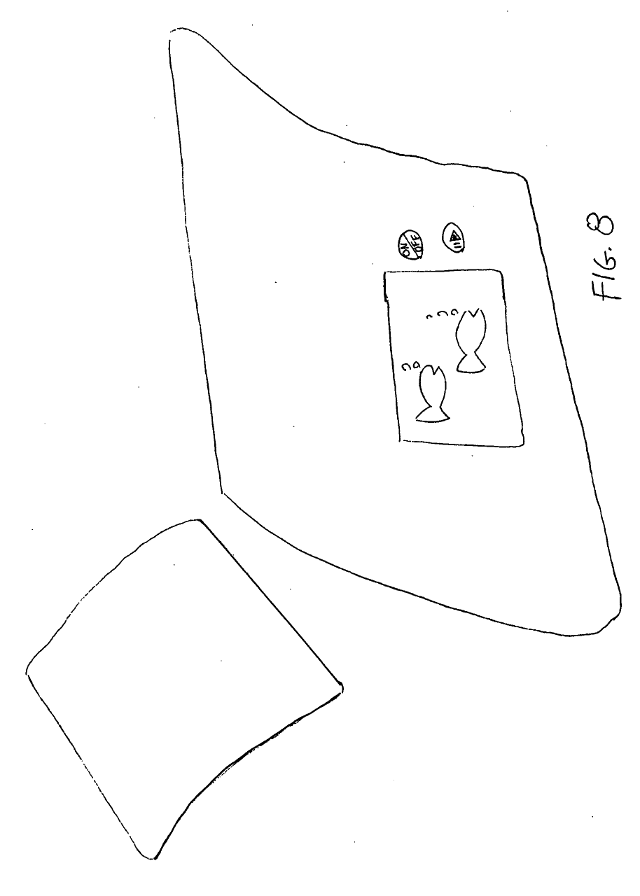

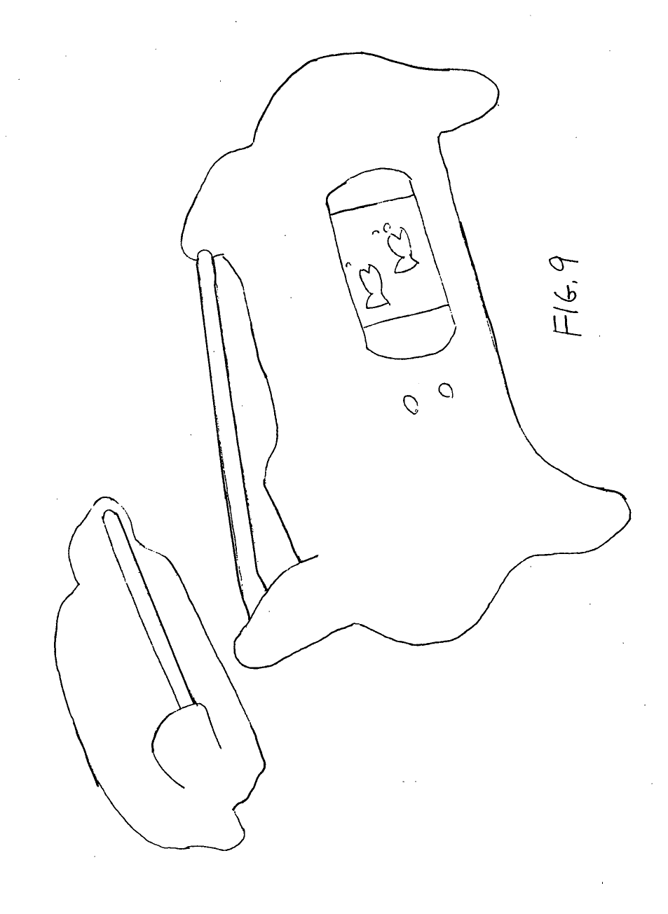

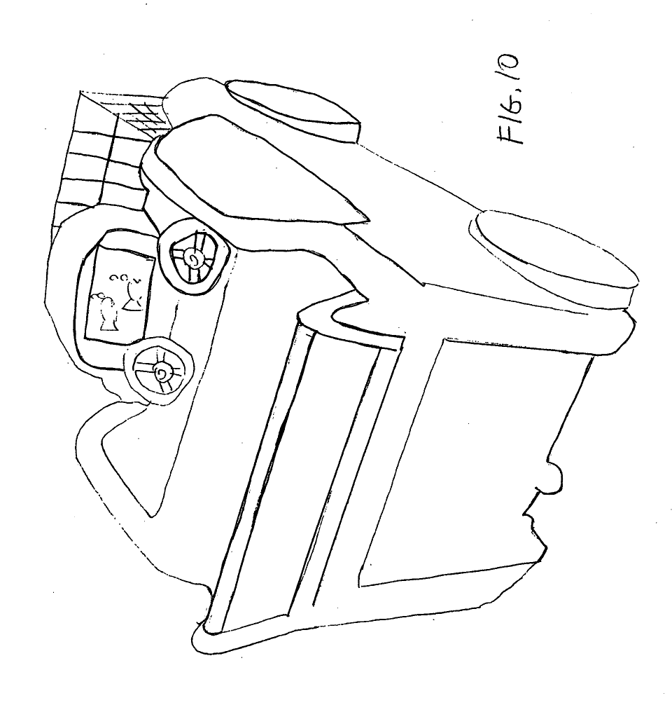

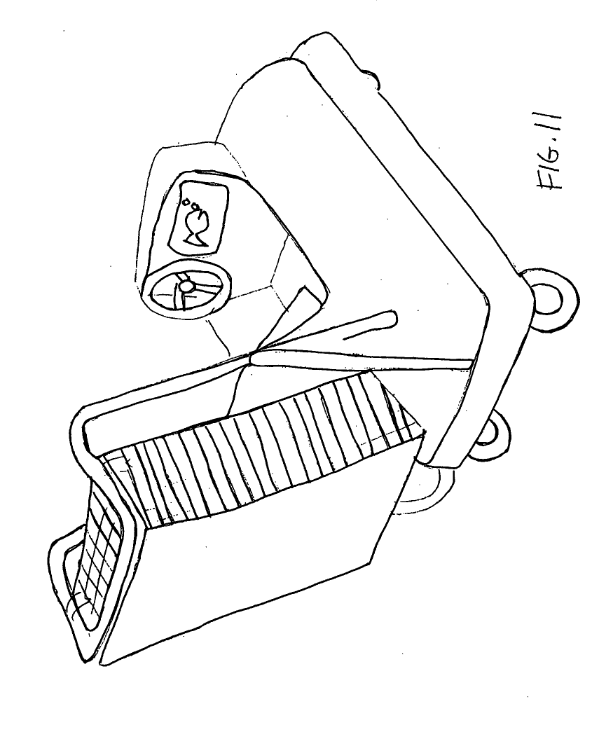

Likewise, the video display and speakers may be positioned in any suitable location in the carrier. As shown in FIGS. 7-11, which depict various exemplary dashboards (FIGS. 7, 10, and 11), mountable panels (FIG. 8), integral panels (FIG. 9), and carriers (FIG. 10 and 11), the video display and speakers may be integral with the carrier, extending therefrom, or attached thereto, as desired. For example, where the carrier is a shopping cart shaped as a car, truck, rocket ship, spacecraft, or otherwise, the video display may be positioned in the dash board as shown in FIGS. 7, 10, and 11 or in a toy control panel of the toy vehicle.

The audio/video system may contain numerous different components, as will be appreciated readily by those of skill in the art. For example, the video display may receive a broadcast from within the store or over the airwaves, or may be coupled to a video cassette recorder, digital videodisk (DVD) player, or the like to allow the display of any entertainment desired.

In one aspect, the system includes a portable memory device containing media content for viewing by the child. The portable memory device may be a flash card, memory stick, jump drive, memory card, pen drive, or any other suitable media storage device. If desired, the device may include a combination integrated circuit and memory device, commercially available from, for example, Matrix Semiconductor, Inc. (Santa Clara, Calif.). The content may be music videos, cartoons, movies, television shows, or any other media content suitable for entertaining a child. The portable memory device may contain multiple viewing options, or may contain a single program for viewing. In either of such instances, the portable memory device may be replaced or updated on a periodic basis to change the content.

In another aspect, the system includes a permanent memory device containing media content for viewing by the child. As with a portable memory device, a permanent storage device may be replaced or updated on a periodic basis to change the content.

The portable storage device may be contained in a housing or otherwise, with the audio/video unit. The system may be integral with the child carrier, may be provided with the child carrier, or may be provided as a separate unit that may be adapted for and mounted to a pre-existing child carrier. It is contemplated that all or a portion of the system may be replaced readily. Thus, for example, if the system breaks or otherwise becomes damaged, the entire system contained within the housing can be removed and replaced with an entire new system. As another example, the individual components of the system, such as the portable or permanent storage device, are accessible readily and may be replaced as needed or desired.

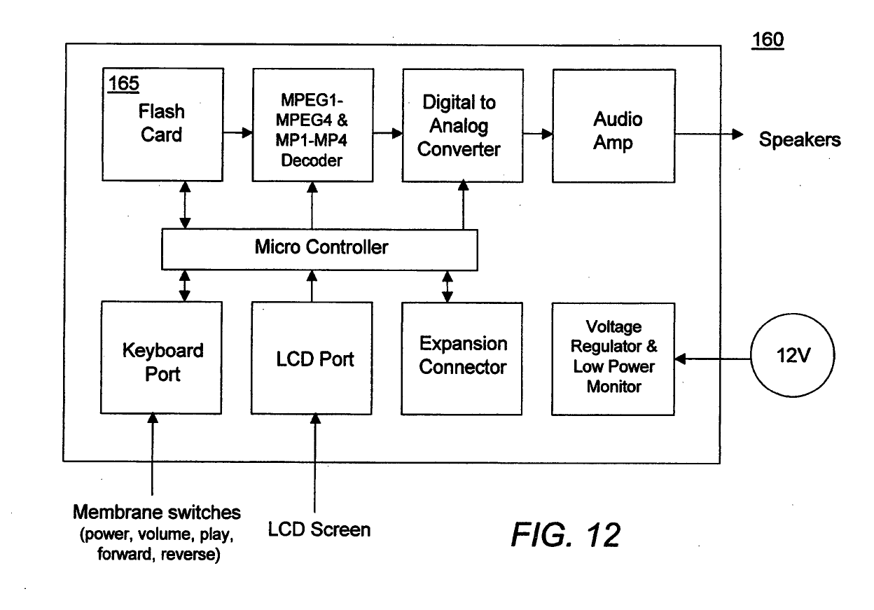

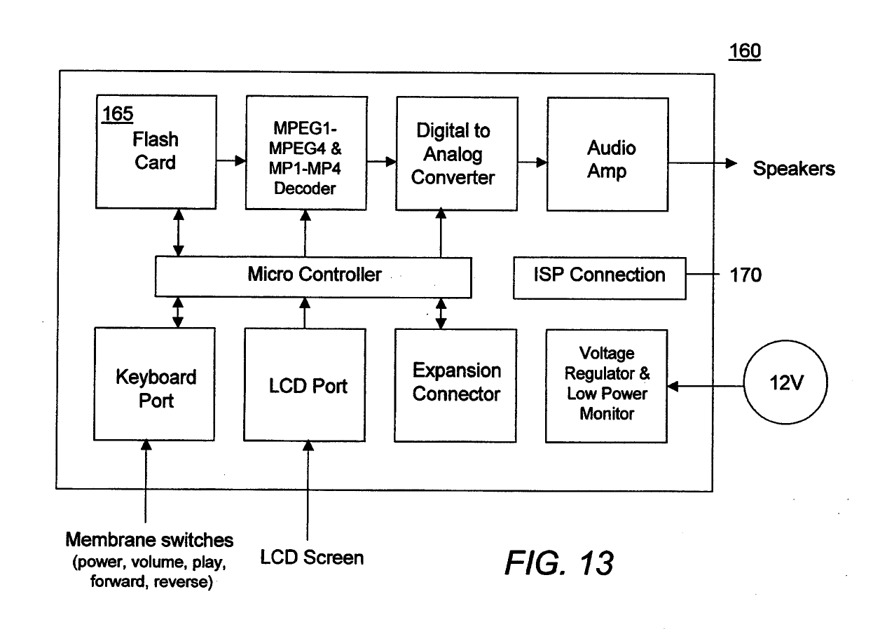

FIGS. 12 and 13 depict exemplary electronic cards 160 for various systems according to the present invention. The exemplary cards 160 include numerous interconnected components, including a memory device. It will be understood that the cards are illustrative only, and are not intended to limit the type of cards used or content thereon. In each of the examples presented, the card includes a flash card 165 for storing the media content. The card of FIG. 13 also includes a feature 170 for receiving information from an internet service provider (ISP).

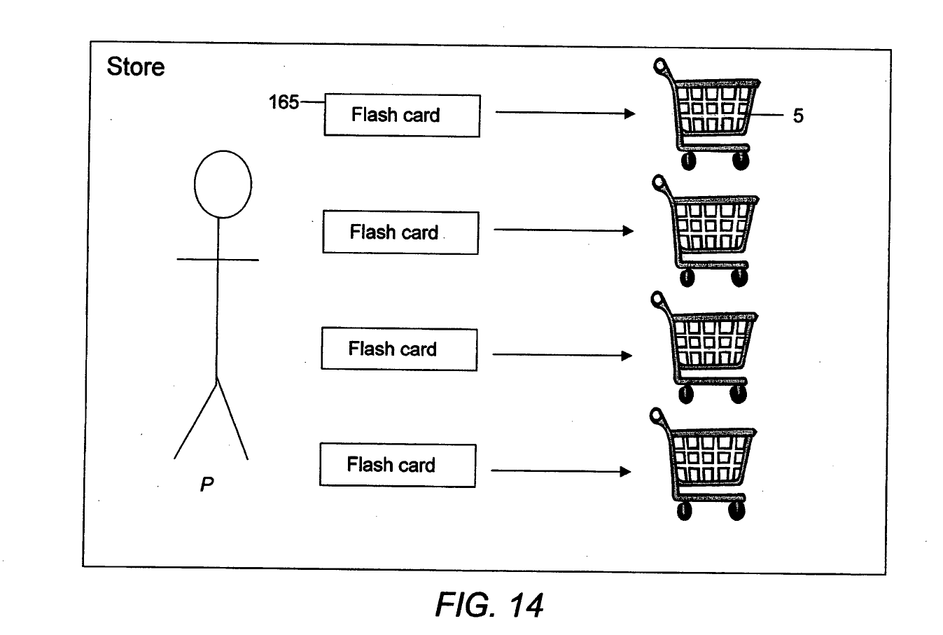

As illustrated in FIG. 14, one example of a system according to various aspects of the present invention includes a plurality of carts 5, each of which contains an electronic card such as the card shown in FIG. 12. The flash card 165 in each cart 5 is replaced periodically by store personnel P to change the media content available for viewing in the cart 5.

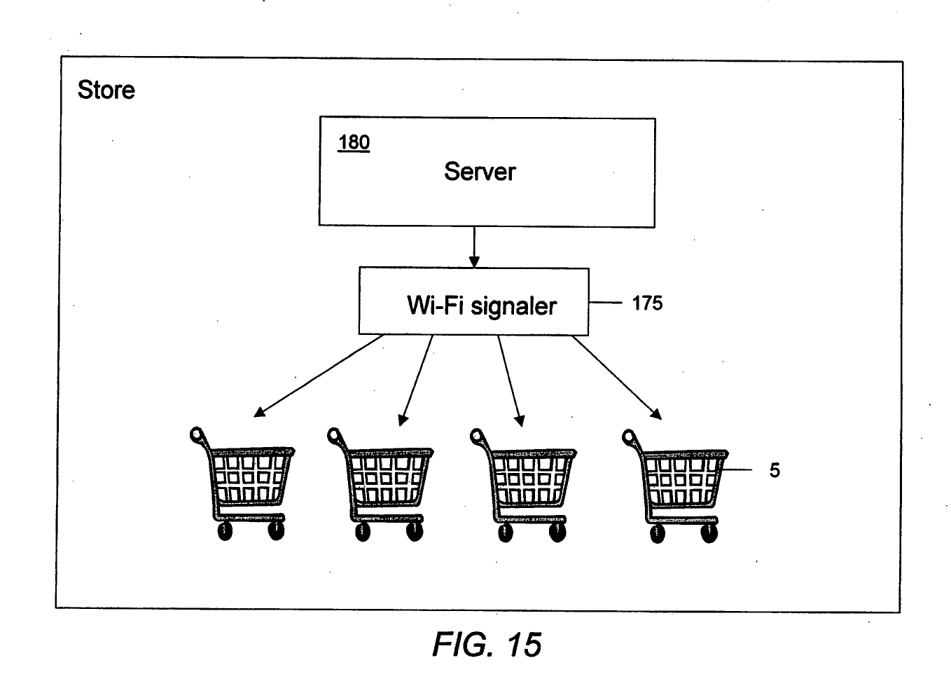

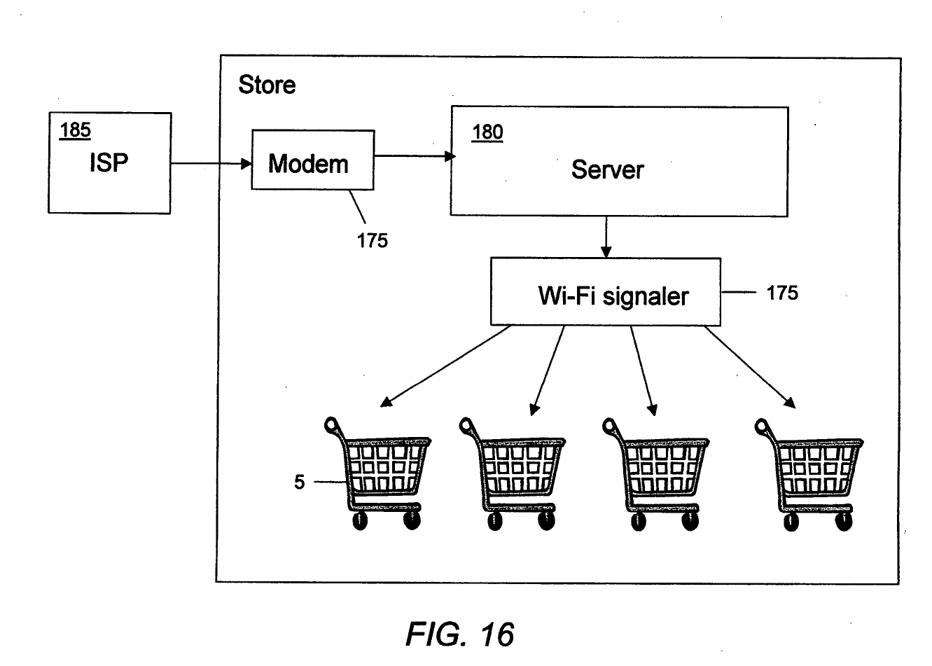

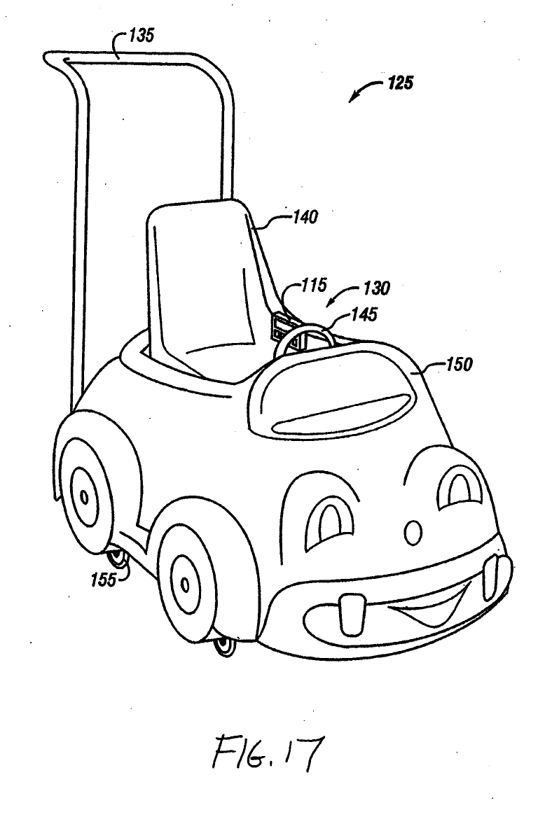

In other aspects illustrated in FIGS. 15 and 16, the system includes wireless streaming content, for example, Wi-Fi 175. In such aspect, a server 180 may be placed within the retailer, amusement park, or other establishment. The server 180 may be used to transmit content to individual carts 5. This presents an advantage over systems in which the content is provided and updated manually. Often, the retailer or other provider forgets to change the content for a long period of time, or has difficulty tracking which carriers have been updated and which have not. Additionally, the server is provided with a source of AC power and, therefore, continuously receives and transmits information. It is contemplated that more than one retailer or provider may be interconnected, so that each retailer or provider receives the content from a central provider at approximately the same time.

In one variation of this aspect, the content is transmitted from the server to the cart or child carrier, where it is stored on a portable memory device or storage medium, for example, a flash card. When the provider wants to change the content, the server is programmed to transmit the new content to the cart or child carrier. The system may be designed to overwrite the old content, or may be designed to add the content. In some cases, the cart or child carrier might need to be brought within a predetermined distance of the server for the new content to be delivered.

In another variation of this aspect, the content is periodically or continuously transmitted to the cart child carrier. In this instance, the content may be changing more frequently as the child views the video and listens to the audio.

In the system illustrated in FIG. 15, each store includes a server 180. The media content is provided to each store on a flash card, CD-ROM, or other storage device. The content is stored on the server 180. A Wi-Fi signaler 175 is connected to the server 180. As each cart 5 passes within a specified distance, for example, 150 feet, of the signaler 175, the media content is transmitted to the cart 5, received by a wireless receiver on the cart, and stored on the flash card or other memory device housed on the cart.

In contrast, the system of FIG. 16 uses an ISP 185 to transmit the media content to each store over the Internet via a modem 190. The media content is downloaded onto the server 180 by each store. As each cart 5 passes within a specified distance, for example, 150 feet, of the Wi-Fi signaler 175, the media content is transmitted to the cart 5, received by a wireless receiver on the cart, and stored on the flash card or other memory device housed on the cart.

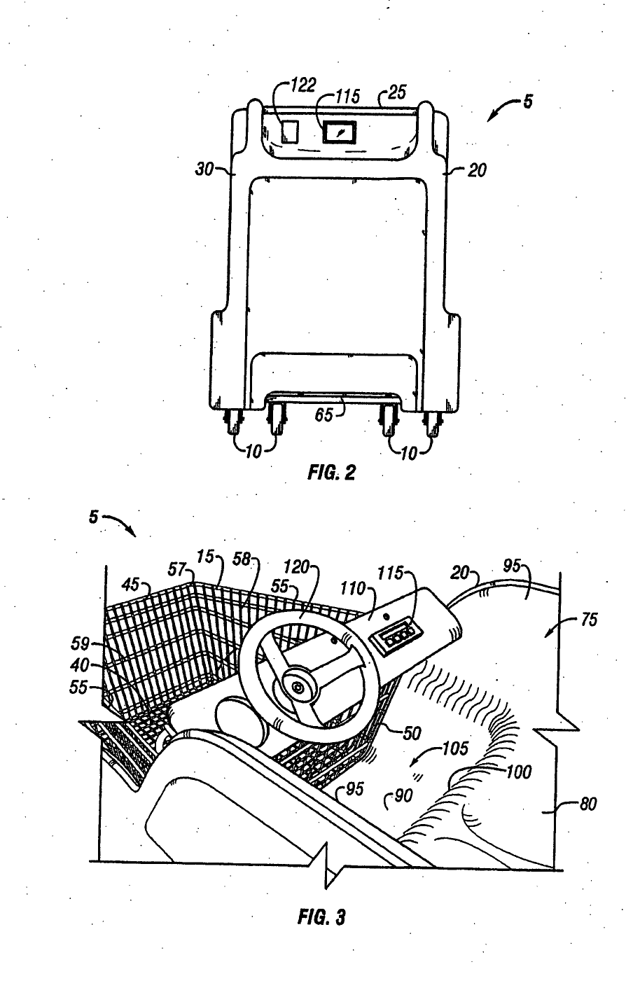

In addition to the above-described devices, another aspect of the cart 5, shown in FIG. 2, employs a small computer (e.g., PDA, calculator, micro-computer, etc.) powered by a rechargeable battery 122. The computer is supported by the cart 5 in a position that allows the shopper to easily view the display. The computer can be used as a calculator to aid the shopper, or can be programmed with locations of various products within the store, or shopping center, to aid the shopper in locating desired products. In another aspect (not shown), the computer is coupled to a portable bar code reader allowing the shopper to scan products as they are placed in the cart 5. This greatly aids the shopper in maintaining a budget, and allows a shopper to review items placed in the cart 5 on the computer screen rather than having to search through the various products within the basket 15.

FIG. 17 shows another aspect of the invention in which an electronic device 115 is provided in a child carrier 125 suitable for carrying children in a retail or other shopping environment. The child carrier 125 does not have a basket like the carts 5 of the previous aspects but rather performs the function of carrying and entertaining the child. The child carrier 125 has a seat region 130 having a push bar 135, a seat 140, and a steering wheel 145, surrounded by the body 150. The body 150 is supported by a plurality of wheels 155. The electronic device 115 is disposed within the body 150 and supported such that children seated within the child carrier 125 can easily access and interact with the electronic device 115. For example, the device 115 could be a television monitor that receives a signal from within the store. The monitor could display cartoons, stories, or educational programs that are of interest to young children. Other aspects of the child carrier 125 include a basket (not shown) to aid the shopper. The basket could be hung from the push bar 135 or supported in some other convenient manner.

In another aspect (not shown), the body is shaped to resemble an animal and the child carrier is used in a zoo or carnival setting. The electronic device could be a radio receiver able to pick up a broadcast emanating from within the zoo. Further, the radio receiver could receive a different signal based on its location allowing, the audio to describe the particular animals in the area.

As a person having ordinary skill in the art will realize, many electronic devices can be adapted to operate within a child carrier or cart as described herein. Thus, any of the systems, devices, and methods described herein may be used with a cart, a child carrier, or any other similar apparatus. In addition, a person having ordinary skill in the art will realize that an electronic device as described herein can be adapted to fit within any molded body commonly used in child carriers. In addition, child carriers that use tubular frames may employ electronic devices disposed within a formed panel or piece that attaches to the child carrier. Thus, the present invention should not be limited to only those aspects described herein.

Accordingly, it will be readily understood by those persons skilled in the art that, in view of the above detailed description of the invention and the appended documents and figures, the present invention is susceptible of broad utility and application. Many adaptations of the present invention other than those herein described, as well as many variations, modifications, and equivalent arrangements will be apparent from or reasonably suggested by the present invention and the above detailed description thereof, without departing from the substance or scope of the present invention.

While the present invention is described herein in detail in relation to specific aspects, it is to be understood that this detailed description is only illustrative and exemplary of the present invention and is made merely for purposes of providing a full and enabling disclosure of the present invention. The detailed description set forth herein is not intended nor is to be construed to limit the present invention or otherwise to exclude any such other aspects, adaptations, variations, modifications, and equivalent arrangements of the present invention.

What is claimed is:

1. A child carrier adapted to carry a rider, the child carrier comprising:
a substantially rigid body defining a seat portion, the seat portion including a plurality of walls and a seat; and
an electronic device disposed at least partially within the seat portion,
wherein the electronic device comprises a display and an interactive device.

2. The child carrier of claim 1, wherein the electronic device comprises a game.

3. The child carrier of claim 1, wherein the display comprises a flat screen, a plasma screen, a computer screen, or a television screen.

4. The child carrier of claim 1, wherein the interactive device comprises a steering wheel.

5. The child carrier of claim 4, wherein the steering wheel is attached to one or more of the plurality of walls.

6. The child carrier of claim 1, wherein the interactive device comprises a joystick.

7. The child carrier of claim 1, further comprising an electrical connector for receiving a headphone plug, wherein the electronic device produces a signal that is directed to the electrical connector.

8. The child carrier of claim 1, further comprising a battery for supplying power to the electronic device.

9. A child carrier adapted to carry a rider, the child carrier comprising:
a substantially rigid body defining a seat portion, the seat portion including a plurality of walls and a seat; and
an electronic device disposed at least partially within the seat portion,
wherein the electronic device comprises:
(a) an audio device;
(b) a video display coupled to a video cassette recorder or a digital videodisk player;
(c) a video display device coupled to an audio/video receiver;
(d) an audio/video storage device coupled to an audio/video playback device; or
(e) any combination thereof.

10. The child carrier of claim 9, wherein the audio device comprises a radio receiver, satellite radio receiver, internal broadcasting system, or any combination thereof.

11. The child carrier of claim 9, wherein the audio device comprises a radio receiver tuned to a pre-determined frequency.

12. The child carrier of claim 9, wherein the audio device comprises a cassette player, compact disc player, minidisk player, digital audio player, or any combination thereof.

13. The child carrier of clam 9, wherein the audio device broadcasts music, stories, narratives, plays, monologues, dialogues, audio books, audio comic books, or any combination thereof.

14. The child carrier of claim 9, further comprising a portable memory device.

15. The child carrier of claim 14, wherein the portable memory device comprises a flash card, memory stick, jump drive, memory card, pen drive, or any combination thereof.

16. The child carrier of claim 15, wherein the portable memory device comprises a combination integrated circuit and memory device.

17. The child carrier of claim 9, wherein the electronic device is adapted to receive wireless streaming media content.

18. The child carrier of claim 9, wherein the electronic device is provided as a separate unit attached to the child carrier.

19. The child carrier of claim 9, wherein the electronic device is provided as an integral unit with the child carrier.

20. A shopping cart adapted to carry a rider, comprising:
a substantially rigid body having a front portion, a rear portion, and a seat region disposed adjacent the rear portion;
a substantially rigid basket received within an opening defined in the front portion of the body, the basket having a base attached to the body and front, rear, and side walls;
a seat disposed between the back and side walls adjacent the rear portion of the body in a position disposed above and behind the base of the basket;
a panel mounted between the seat and the basket; and
a plurality of wheels attached to the body,
wherein the seat region comprises an audio/video playback device positioned along the panel for access by the rider and an electronic device mounted along the back wall of the seat region.

21. A method of providing wireless media content to a child carrier in an establishment, comprising:
(a) providing a wireless server within the establishment;
(b) providing a wireless receiver within the child carrier; and
(c) transmitting media content to the child carrier.

22. The method of claim 21, further comprising storing the transmitted media content on a portable memory device on the child carrier.

23. The method of claim 22, further comprising transmitting new media content to the child carrier and overwriting at least a portion of the previously stored media content.
